(19) United States
(12) Patent Application Publication
(10) Pub. No.: US 2021/0385806 A1
(43) Pub. Date: Dec. 9, 2021

(54) ELECTRONIC DEVICE, WIRELESS COMMUNICATION METHOD AND COMPUTER READABLE MEDIUM

(71) Applicant: Sony Group Corporation, Tokyo (JP)

(72) Inventors: Qimei CUI, Beijing (CN); Zhenyu XU, Beijing (CN); Tao CUI, Beijing (CN); Xiaofeng TAO, Beijing (CN); Bowen CAI, Beijing (CN); Jing LIU, Beijing (CN)

(73) Assignee: Sony Group Corporation, Tokyo (JP)

(21) Appl. No.: 17/285,494

(22) PCT Filed: Nov. 21, 2019
(86) PCT No.: PCT/CN2019/119891

§ 371 Date: Apr. 15, 2021

(30) Foreign Application Priority Data
Nov. 28, 2018 (CN) 201811433521.0

(51) Int. Cl. H04W 72/04; H04W 16/14; H04L 1/18

(52) U.S. Cl. CPC H04W 72/0406; H04L 1/1812; H04W 16/14

(57) ABSTRACT

The present disclosure relates to an electronic device, a wireless communication method, and a computer readable medium. The electronic device for wireless communication according to one embodiment comprises a processing circuit. The processing circuit is configured to: perform control, so as to perform channel idle detection on an unlicensed band at a predetermined bandwidth; and perform control on the basis of a result of the channel idle detection, so as to transmit a hybrid automatic retransmission request on one or more sub-bandwidth blocks having the predetermined bandwidth.

### FIELD

The present disclosure generally relates to the field of wireless communication, and more specifically, to an electronic device, a wireless communication method, and a computer readable medium for wireless communication.

### BACKGROUND

When an unlicensed band is used by user equipment (UE) and a base station for wireless communication, in order to ensure fair coexistence with another system that uses an unlicensed band, such as wireless fidelity (WIFI), it is necessary to perform listen before talk (LBT) before a channel is accessed.

A hybrid automatic repeat request (HARQ) can be transmitted in a physical uplink control channel (PUCCH) or a physical uplink shared channel (PUSCH). When the UE has uplink data in the PUSCH resource, it needs to transmit the HARQ together with the uplink data in the PUSCH, and the transmission of the HARQ does not need to be scheduled.

### SUMMARY

Inherent delay and discontinuous transmission in an unlicensed band may be caused due to the need to perform LBT. The UE or the base station only keeps a channel during channel occupation time (COT).

In addition, LBT is also required when the HARQ is transmitted in the unlicensed band. Due to possible failure of LBT, the HARQ may be blocked or may have a relative high delay.

A brief summary of the embodiment of the present disclosure is given below in order to provide a basic understanding of certain aspects of the present disclosure. It should be understood that the following summary is not an exhaustive summary of the present disclosure. The summary is not intended to determine the key or important part of the present disclosure, nor is it intended to limit the scope of the present disclosure, but merely to give certain concepts in a simplified form as a prelude to the more detailed description later on.

According to one embodiment, an electronic device for wireless communication is provided, which includes processing circuitry. The processing circuitry is configured to perform control to perform channel idle detection on an unlicensed band with a predetermined bandwidth. The processing circuitry is further configured to perform control based on a result of the channel idle detection to transmit a hybrid automatic repeat request on one or more sub-bandwidth blocks having the predetermined bandwidth.

According to another embodiment, a wireless communication method includes a step of performing channel idle detection on an unlicensed band with a predetermined bandwidth. The method further includes a step of transmitting a hybrid automatic repeat request on one or more sub-bandwidth blocks having the predetermined bandwidth based on a result of the channel idle detection.

According to yet another embodiment, an electronic device for wireless communication is provided, which includes processing circuitry. The processing circuitry is configured to perform control to receive a hybrid automatic repeat request on at least one sub-bandwidth block of an unlicensed band which has a predetermined bandwidth. The hybrid automatic repeat request is transmitted by user equipment on one or more sub-bandwidth blocks based on a result of channel idle detection performed with the predetermined bandwidth.

According to still another embodiment, a wireless communication method includes a step of receiving a hybrid automatic repeat request on at least one sub-bandwidth block of an unlicensed band which has a predetermined bandwidth. The hybrid automatic repeat request is transmitted by user equipment on one or more sub-bandwidth blocks based on a result of channel idle detection performed with the predetermined bandwidth.

The embodiment of the present disclosure further includes a computer readable medium, which includes executable instructions that, when executed by an information processing apparatus, cause the information processing apparatus to implement the method according to the foregoing embodiment.

Through the embodiment of the present disclosure, HARQ can be transmitted with the unlicensed band in a more efficient way.

### BRIEF DESCRIPTION OF THE DRAWINGS

The present disclosure can be better understood by referring to the description given below in connection with the accompanying drawings, in which the same or similar reference numerals are used in all drawings to denote the same or similar components. The drawings together with the following detailed description are included in the specification and form a part of the specification, and are used to further illustrate the preferred embodiments of the present disclosure and explain the principles and advantages of the present disclosure. In the drawings:

FIG. 1 is a block diagram showing a configuration example of an electronic device for wireless communication according to an embodiment of the present disclosure;

FIG. 2 is a block diagram showing a configuration example of the electronic device for wireless communication according to another embodiment;

FIG. 3 is a flowchart showing a process example of a wireless communication method according to an embodiment of the present disclosure;

FIG. 4 is a block diagram showing a configuration example of an electronic device for wireless communication according to an embodiment of the present disclosure;

FIG. 5 is a block diagram showing a configuration example of the electronic device for wireless communication according to another embodiment;

FIG. 6 is a flowchart showing a process example of a wireless communication method according to an embodiment;

FIG. 7 shows a transmission process of a HARQ in an exemplary embodiment;

FIG. 8 shows a transmission process of the HARQ in another exemplary embodiment;

FIG. 9 is a schematic diagram for explaining that LBT is performed for different sub-bandwidth blocks;

FIG. 10 is a schematic diagram for explaining a scenario of congestion detection;

FIG. 11 shows a transmission process of a HARQ in an exemplary embodiment;

FIG. 12 is a block diagram showing an exemplary structure of a computer that implements the method and device according to the present disclosure;

FIG. 13 is a block diagram showing an example of an exemplary configuration of a smart phone to which the technology according to the present disclosure can be applied; and

FIG. 14 is a block diagram showing an example of an exemplary configuration of gNB (a base station in a 5G system) to which the technology according to the present disclosure can be applied.

### DETAILED DESCRIPTION OF THE EMBODIMENTS

Hereinafter, embodiments of the present disclosure will be described with reference to the drawings. The elements and features described in one drawing or one embodiment of the present disclosure may be combined with the elements and features shown in one or more other drawings or embodiments. It should be noted that, for the purpose of clarity, representation and description for components and processes that are not related to the present disclosure and known to those of ordinary skill in the art are omitted in the drawings and descriptions.

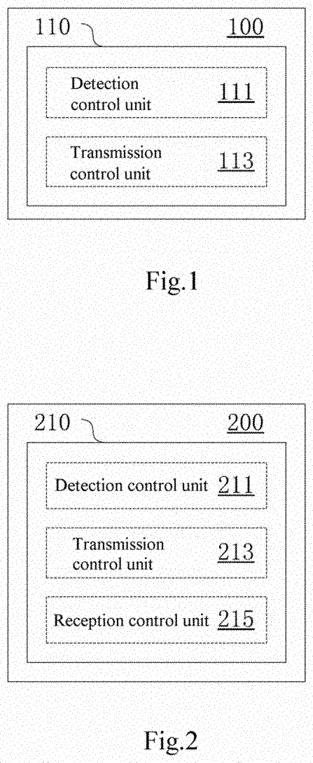

As shown in FIG. 1, an electronic device 100 for wireless communication according to the present embodiment includes processing circuitry 110. The processing circuitry 110 may, for example, be implemented as a specific chip, a chipset, a central processing unit (CPU) or the like.

The processing circuitry 110 includes a detection control unit 111 and a transmission control unit 113. It should be pointed out that although the detection control unit 111 and the transmission control unit 113 are shown in a form of functional blocks in the drawings, it should be understood that the functions of respective units may be realized by the processing circuitry as a whole, but not necessarily realized by separate actual components in the processing circuitry. In addition, although the processing circuitry is shown in a block in the figure, the electronic device may include multiple processing circuitry, and the functions of respective units may be distributed to the multiple processing circuitry, so that the functions are executed by the multiple processing circuitry in cooperation.

The detection control unit 111 is configured to perform control to perform channel idle detection on an unlicensed band with a predetermined bandwidth.

In other words, the channel idle detection may be performed respectively on multiple sub-bandwidth blocks of a bandwidth block with the predetermined bandwidth. The predetermined bandwidth may be the minimum unit of the channel idle detection, for example, it may be 20 MHz. However, the present disclosure is not limited to this, and the division for the sub-bandwidth blocks may be performed according to different predetermined bandwidths as needed.

In addition, the channel idle detection is briefly described. When a communication device (which may include user equipment or a base station) generally needs to perform LBT before accessing an unlicensed channel. The communication device is required to perform at least clear channel assessment (CCA) detection, that is, energy detection. When it is detected that the energy of the unlicensed band exceeds a threshold, it indicates that the unlicensed channel has been occupied.

Taking a predetermined bandwidth of 20 MHz as an example, for a bandwidth block of an unlicensed band, it is assumed that the UE and the base station need to perform LBT on all 20 MHz units on the entire bandwidth block, and then select a 20 MHz unit for which LBT has been performed successfully to transmit data and a HARQ, and the HARQ does not need to be scheduled. In this case, a position of the HARQ in the selected 20 MHz sub-bandwidth block cannot be determined, and the base station needs to detect all sub-bandwidth blocks to obtain a HARQ feedback, which is inefficient and may reduce the success rate of the transmission of the HARQ, thereby resulting in a delay in data transmission.

According to the present embodiment, the transmission control unit 113 is configured to perform control based on a result of the channel idle detection to transmit the HARQ on one or more sub-bandwidth blocks having the predetermined bandwidth.

More specifically, the transmission control unit 113 is configured to select at least one sub-bandwidth block from sub-bandwidth blocks which are indicated to be idle by the channel idle detection, for transmitting the HARQ.

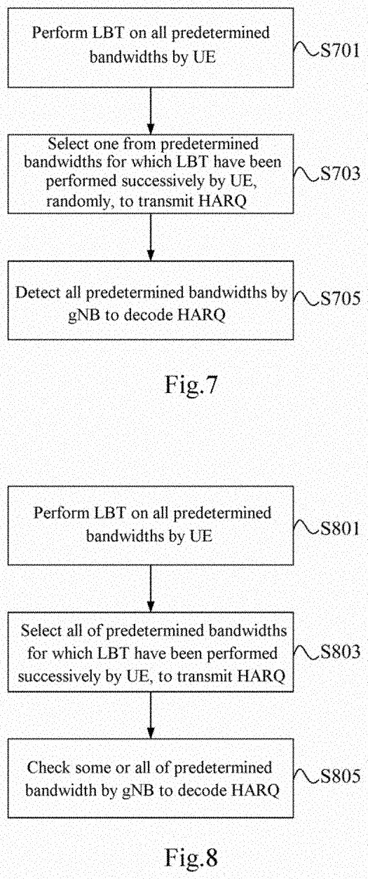

For example, as shown in FIG. 7, UE may perform LBT on all 20 MHz sub-bandwidth blocks on the bandwidth block (S701), and may select a 20 MHz sub-bandwidth block for which LBT has been performed successively, randomly, to transmit the HARQ and uplink data (S703).

In this case, a base station side needs to detect all sub-bandwidth blocks of the entire bandwidth block to obtain the HARQ feedback (S705).

Alternatively, the transmission control unit 113 may be configured to transmit the HARQ on each sub-bandwidth block which is indicated to be idle by the channel idle detection.

For example, as shown in FIG. 8, the UE may perform LBT on all 20 MHz sub-bandwidth blocks of the bandwidth block (S801), and perform the HARQ feedback on all 20 MHz sub-bandwidth blocks for which LBT have been performed successively (S803). Thereby, redundancy is introduced for the transmission of the HARQ. The base station may check all 20 MHz sub-bandwidth blocks or only part of the 20 MHz sub-bandwidth blocks to decode the HARQ (S805), which can reduce the complexity of acquiring the HARQ on the base station side, and contribute to the reliability of performing decode on acknowledge/non-acknowledge (ACK/NACK).

The UE transmitting the HARQ on multiple or all sub-bandwidth blocks means that multiple resources need to be configured, and multiple PUCCH/PUSCH resources for the transmission of the HARQ need to be considered.

An alternative solution is to provide multiple PUCCH/PUSCH resources across the entire bandwidth block. The solution requires all sub-bandwidth blocks to be configured with HARQ resource, and the operation complexity on the base station side will be reduced. The base station may select one, several or all sub-bandwidth blocks to obtain the HARQ feedback. In addition, the solution can improve the reliability of ACK/NACK decoding.

Another alternative solution is to limit the resource on part of the sub-bandwidth blocks.

Correspondingly, according to an embodiment, the transmission control unit 113 may be configured to transmit the HARQ on sub-bandwidth blocks belonging to a predetermined set of sub-bandwidth blocks among sub-bandwidth blocks which are indicated to be idle by the channel idle detection. For example, the predetermined set of sub-bandwidth blocks may be configured by the base station.

The solution can reduce the configured resources while improving the success rate of the transmission of the HARQ. In addition, the processing complexity on the UE side can be reduced and the bit amount of transmission can be saved for data transmission.

In addition, the channel idle detection for different sub-bandwidth blocks may be completed at different time. According to an embodiment, the transmission control unit 113 may be configured to perform control to transmit the HARQ earlier on a sub-bandwidth block which passes the channel idle detection earlier.

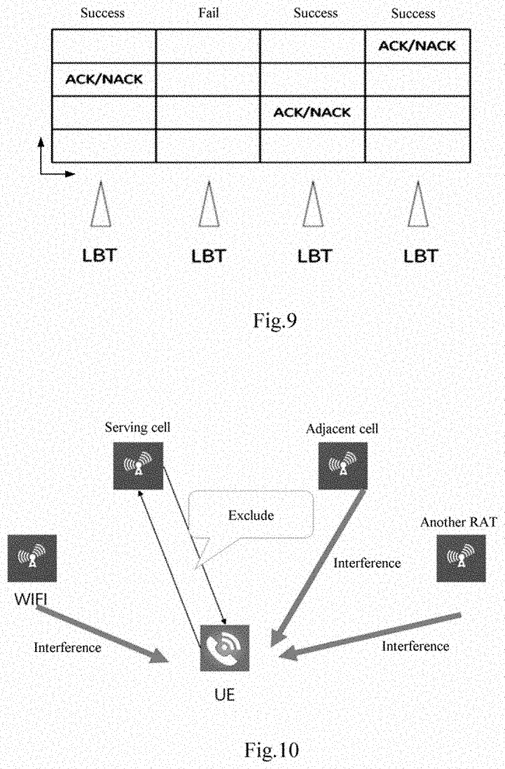

For example, in the schematic diagram of FIG. 9, a horizontal axis corresponds to frequency, that is, different sub-bandwidth blocks, and a vertical axis corresponds to time. The channel idle detection for different sub-bandwidth blocks may be completed at different time, and the HARQ may be transmitted earlier on a sub-bandwidth block which passes the channel idle detection earlier, and it is not necessary to transmit the HARQ on different sub-bandwidth blocks at the same time.

In the foregoing embodiment, an example in which the UE randomly selects a sub-bandwidth block with successful channel idle detection to perform the transmission of the HARQ has been described, however the UE may also select a sub-bandwidth block with another method.

According to an embodiment, the transmission control unit 113 may be configured to select, according to a result of the channel idle detection, one or more sub-bandwidth blocks with high idle degree for the HARQ. The idle degree may be determined based on a received signal strength indication.

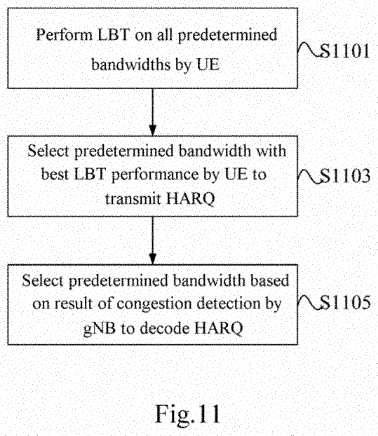

For example, the UE and the base station may select the 20 MHz sub-bandwidth block with the best LBT performance. More specifically, as shown in FIG. 11, the UE may perform LBT on all 20 MHz sub-bandwidth blocks (S1101), and select the 20 MHz sub-bandwidth block with the best LBT performance as a transmission position (S1103). The best LBT performance refers to the lowest energy detection. The UE may compare the detected energy with a predetermined threshold, and select a sub-bandwidth block whose energy is lower than the threshold. In addition, the LBT performance may also take into account the time consumption of the LBT process.

On the other hand, the base station side also performs LBT on sub-bandwidth blocks, and selects one or more of the best sub-bandwidth blocks to receive the HARQ (S1105).

Since both the UE side and the base station side perform selection based on LBT detection, there is a high possibility that the UE side and the base station side may select the same or close sub-bandwidth blocks.

In addition, in order to further improve the possibility that the UE side and the base station side select the same or close sub-bandwidth blocks, a congestion detection may be performed. The congestion detection is performed for interference from an adjacent cell or another radio access technology (RAT), and the signal of a current serving cell is not regarded as interference in the congestion detection, as shown in FIG. 10.

Correspondingly, according to an embodiment, the detection control unit 111 may be configured to remove the influence of a downlink signal of the current serving cell in the channel idle detection.

In addition, in order to reduce the interference of other UE in the same cell to the current UE, the base station may, for example, indicate downlink COT to the UE served by the base station through signaling (the base station does not permit downlink transmission outside the COT), and the base station may notify another UE of the COT of the current UE to avoid interference from other UE in the cell on the current UE.

Through the configuration, measurement result of the UE such as received signal strength indication (RSSI), excludes the interference in the same cell, and may be used as a standard for the congestion detection. The RSSI may be measured in each of sub-bandwidth blocks of the entire bandwidth block, thereby improving an accuracy of decision-making.

FIG. 2 shows a configuration example of an electronic device for wireless communication according to an embodiment. The electronic device 200 includes processing circuitry 210. The processing circuitry 210 includes a detection control unit 211, a transmission control unit 213, and a reception control unit 215. The detection control unit 211 and the transmission control unit 213 are similar to the detection control unit 111 and the transmission control unit 113 described above.

The reception control unit 215 is configured to perform control to receive indication information related to uplink channel occupation time transmitted by the base station.

In addition, the transmission control unit 213 is further configured to not perform signal transmission during the indicated uplink channel occupation time.

Through the embodiment, for example, interference to other UE in the same cell can be reduced, thereby facilitating selection for sub-bandwidth blocks.

In the foregoing description of the device according to the embodiment of the present disclosure, it is obvious that some procedures and methods are also disclosed. Next, an explanation of the wireless communication method according to the embodiment of the present disclosure is given without repeating the details that have been described above.

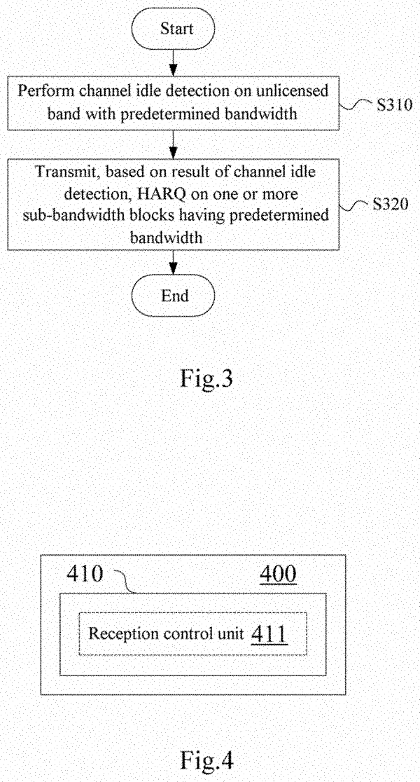

As shown in FIG. 3, according to an embodiment, a wireless communication method includes a step S310 of performing channel idle detection on an unlicensed band with a predetermined bandwidth, and a step S320 of transmitting, based on a result of the channel idle detection, a HARQ on one or more sub-bandwidth blocks having the predetermined bandwidth.

The embodiment corresponding to the UE side is described above. In addition, the embodiments of the present disclosure also include a device and a method implemented on the base station side.

Next, a description of the embodiment for the base station is given without repeating the content corresponding to the details described for the embodiment of the UE side above.

As shown in FIG. 4, according to an embodiment, an electronic device for wireless communication includes processing circuitry 410. The processing circuitry 410 includes a reception control unit 411.

The reception control unit 411 is configured to perform control to receive a HARQ on at least one sub-bandwidth block of an unlicensed band which has a predetermined bandwidth. The HARQ is transmitted by user equipment on one or more sub-bandwidth blocks based on a result of channel idle detection performed with the predetermined bandwidth.

The reception control unit 411 may be configured to perform control to perform detection on each of sub-bandwidth blocks of the allocated unlicensed band for receiving the HARQ.

The reception control unit 411 may be also configured to select part of the sub-bandwidth blocks in the sub-bandwidth blocks of the allocated unlicensed band for receiving the HARQ.

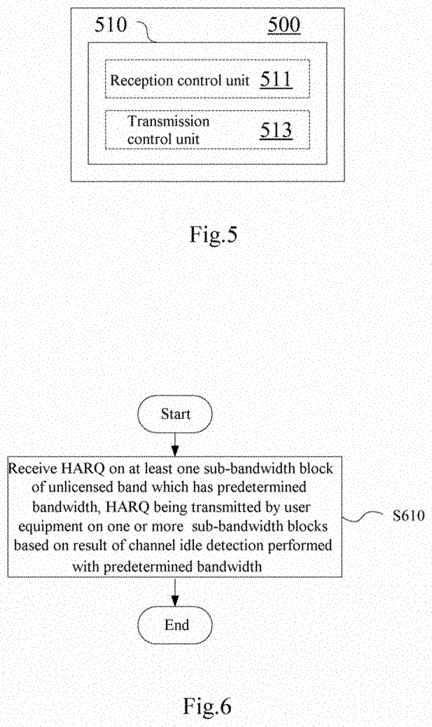

As shown in FIG. 5, according to an embodiment, an electronic device 500 for wireless communication includes processing circuitry 510. The processing circuitry 510 includes a reception control unit 511 and a transmission control unit 513.

The reception control unit 511 may be configured to perform control to perform detection on a predetermined set of sub-bandwidth blocks of the allocated unlicensed band for receiving the HARQ.

The transmission control unit 513 may be configured to perform control to transmit indication information related to the predetermined set of sub-bandwidth blocks to the user equipment.

Still referring to FIG. 5, according to an embodiment, the reception control unit 511 may be configured to perform control to perform channel idle detection on the unlicensed band with the predetermined bandwidth, and receive the HARQ on one or more sub-bandwidth blocks with high idle degree.

The transmission control unit 513 may be configured to perform control to transmit indication information related to downlink channel occupation time of the unlicensed band to target user equipment (from which the HARQ is to be received).

The transmission control unit 513 may further be configured to perform control to transmit indication information related to uplink channel occupation time to user equipment other than the target user equipment.

As shown in FIG. 6, according to an embodiment, the wireless communication method includes a step S610 of receiving a HARQ on at least one sub-bandwidth block of an unlicensed band which has a predetermined bandwidth. The HARQ is transmitted by user equipment on one or more sub-bandwidth blocks based on a result of channel idle detection performed with the predetermined bandwidth.

In addition, an embodiment of the present disclosure further includes a computer readable medium including executable instructions that, when executed by an information processing apparatus, cause the information processing apparatus to implement the method according to the foregoing embodiments.

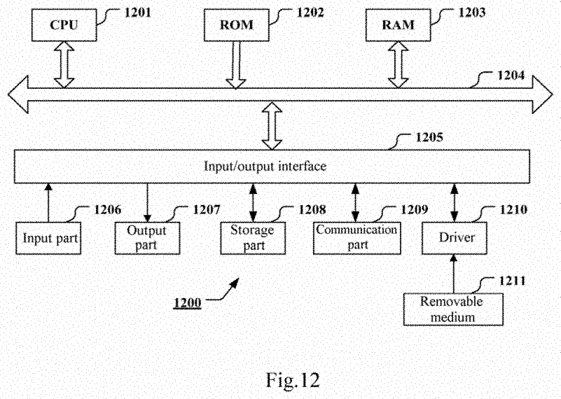

As an example, various steps of the methods above and various modules and/or units of the devices above may be implemented as software, firmware, hardware or a combination thereof. In a case of being implemented by software or firmware, programs constituting the software for implementing the methods above are installed to a computer with a dedicated hardware structure (for example, a general-purpose computer 1200 shown in FIG. 12) from a storage medium or network. The computer may perform various functions when installed with various programs.

In FIG. 12, an arithmetic processing unit (i.e., CPU) 1201 performs various processing according to programs stored in a read only memory (ROM) 1202 or programs loaded from a storage part 1208 to a random access memory (RAM) 1203. The data required when the CPU 1201 executes various processing or the like may be stored in the RAM 1203 as needed. The CPU 1201, the ROM 1202, and the RAM 1203 are linked to each other via a bus 1204. The input/output interface 1205 is also linked to the bus 1204.

The following components are linked to the input/output interface 1205: an input part 1206 (including a keyboard, a mouse or the like), an output part 1207 (including a display, such as a cathode ray tube (CRT) and a liquid crystal display (LCD), a loudspeaker or the like), a storage part 1208 (including a hard disk and so on), and a communication part 1209 (including a network interface card such as a LAN card, and a modem). The communication part 1209 performs communication processing via a network such as the Internet. The driver 1210 may also be linked to the input/output interface 1205 as needed. A removable medium 1211 such as a magnetic disk, an optical disk, a magnetic-optical disk and a semiconductor memory may be installed on the driver 1210 as needed, such that computer programs read from the removable medium 1211 are installed on the storage part 1208 as needed.

In a case of performing the series of processing described above by software, programs constituting the software are installed from network such as the Internet or the storage medium, such as, the removable medium 1211.

Those skilled in the art should understand that the storage medium is not limited to the removable medium 1211 shown in FIG. 12 that has a program stored therein and is distributed separately from the device so as to provide the program to a user. Examples of the removable medium 1211 include: a magnetic disk (including a floppy disk (registered trademark)), an optical disk (including a compact disk read only memory (CD-ROM) and a digital versatile disk (DVD)), a magnetic-optical disk (including a mini disk (MD) (registered trademark)), and a semiconductor memory. Alternatively, the storage medium may be a hard disk included in the ROM 1202 and the storage part 1208 or the like. The storage medium has a program stored therein and is distributed to the user together with a device in which the storage medium is included.

A program product having machine readable instruction codes stored therein is further provided according to an embodiment of the present disclosure. The instruction codes, when read and executed by the machine, perform the method according to the embodiments of the present disclosure.

Accordingly, a storage medium for carrying the above program product having the machine readable instruction codes stored therein is also included in the disclosure. The storage medium includes but is not limited to a floppy disc, an optical disc, a magnetic optical disc, a memory card, a memory stick or the like.

The following electronic device is involved in the embodiments of the present disclosure. In a case that the electronic device is used for base station side, the electronic device may be implemented as any type of gNB or evolved node B (eNB), such as a macro eNB and a small eNB. The small eNB may be an eNB that covers a cell smaller than a macro cell, such as a pico eNB, a micro eNB and a home (femto) eNB. Alternatively, the electronic device may be implemented as any other types of base stations, such as a NodeB and a base transceiver station (BTS). The electronic device may include: a body configured to control wireless communication (which is also referred to as a base station device); and one or more remote radio heads (RRH) disposed at a position different from the body. In addition, various types of terminals, which will be described below, may each operate as the base station by temporarily or semi-persistently executing a base station function.

In a case that the electronic device is used for a user equipment side, the electronic device may be implemented as a mobile terminal (such as a smart phone, a tablet personal computer (PC), a notebook PC, a portable game terminal, a portable/dongle mobile router and a digital camera) or an in-vehicle terminal (such as a car navigation device). Furthermore, the electronic device may be a wireless communication module (such as an integrated circuit module including a single die or multiple dies) mounted on each of the terminals described above.

[Application Example with Regard to Terminal Equipment]

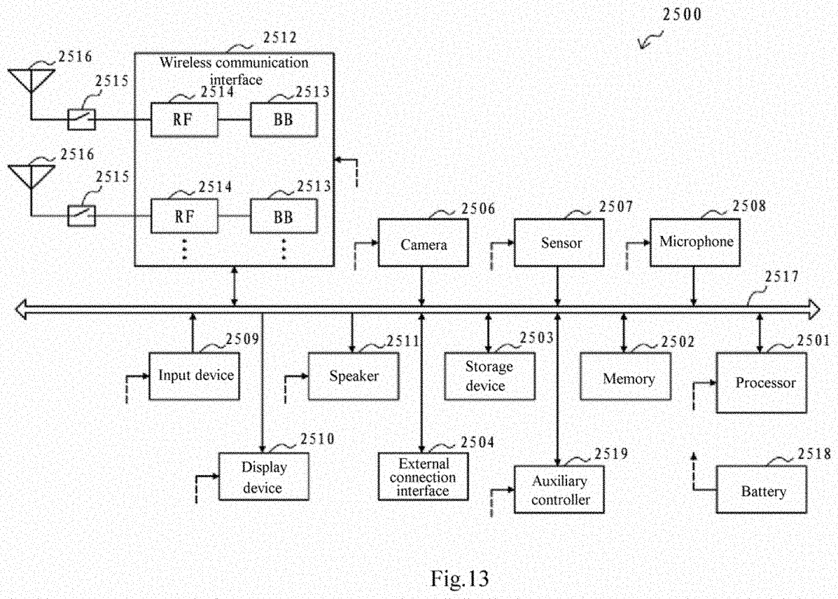

FIG. 13 is a block diagram illustrating an example of exemplary configuration of a smart phone 2500 to which the technology of the present disclosure may be applied. The smart phone 2500 includes a processor 2501, a memory 2502, a storage device 2503, an external connection interface 2504, a camera 2506, a sensor 2507, a microphone 2508, an input device 2509, a display device 2510, a speaker 2511, a wireless communication interface 2512, one or more antenna switches 2515, one or more antennas 2516, a bus 2517, a battery 2518 and an auxiliary controller 2519.

The processor 2501 may be, for example, a CPU or a system on chip (SoC), and controls functions of an application layer and another layer of the smart phone 2500. The memory 2502 includes an RAM and an ROM, and stores programs executed by the processor 2501 and data. The storage device 2503 may include a storage medium such as a semiconductor memory and a hard disk. The external connection interface 2504 is an interface for connecting an external device (such as a memory card and a universal serial bus (USB) device) to the smart phone 2500.

The camera 2506 includes an image sensor (such as a charge coupled device (CCD) and a complementary metal oxide semiconductor (CMOS)), and generates a captured image. The sensor 2507 may include a group of sensors such as a measurement sensor, a gyro sensor, a geomagnetic sensor, and an acceleration sensor. The microphone 2508 converts sound that is inputted to the smart phone 2500 into an audio signal. The input device 2509 includes, for example, a touch sensor configured to detect touch onto a screen of the display device 2510, a keypad, a keyboard, a button, or a switch, and receive an operation or information inputted from a user. The display device 2510 includes a screen such as a liquid crystal display (LCD) and an organic light-emitting diode (OLED) display, and displays an output image of the smart phone 2500. The speaker 2511 converts an audio signal that is outputted from the smart phone 2500 to sound.

The wireless communication interface 2512 supports any cellular communication scheme (such as LTE and LTE-advanced), and performs wireless communication. The wireless communication interface 2512 may include, for example, a baseband (BB) processor 2513 and radio frequency (RF) circuit 2514. The BB processor 2513 may perform for example coding/decoding, modulation/demodulation and multiplexing/de-multiplexing, and perform various types of signal processing for wireless communication. Meanwhile, the RF circuit 2514 may include for example, a mixer, a filter and an amplifier, and transmits and receives a wireless signal via the antenna 2516. The wireless communication interface 2512 may be a chip module on which the BB processor 2513 and the RF circuit 2514 are integrated. As shown in FIG. 13, the wireless communication interface 2512 may include multiple BB processors 2513 and multiple RF circuits 2514. Although FIG. 13 shows the example in which the wireless communication interface 2512 includes the multiple BB processors 2513 and the multiple RF circuits 2514, the wireless communication interface 2512 may also include a single BB processor 2513 or a single RF circuit 2514.

Furthermore, in addition to the cellular communication scheme, the wireless communication interface 2512 may support another type of wireless communication scheme, such as a short-range wireless communication scheme, a near field communication scheme and a wireless local area network (LAN) scheme. In this case, the wireless communication interface 2512 may include the BB processor 2513 and the RF circuit 2514 for each wireless communication scheme.

Each of the antenna switches 2515 switches a connection destination of the antenna 2516 among multiple circuits (such as circuits for different wireless communication schemes) included in the wireless communication interface 2512.

Each of the antennas 2516 includes a single or multiple antenna elements (such as multiple antenna elements included in an MIMO antenna), and is used for the wireless communication interface 2512 to transmit and receive a wireless signal. The smart phone 2500 may include the multiple antennas 2516, as shown in FIG. 13. Although FIG. 13 illustrates the example in which the smart phone 2500 includes the multiple antennas 2516, the smart phone 2500 may also include a single antenna 2516.

Furthermore, the smart phone 2500 may include the antenna 2516 for each wireless communication scheme. In this case, the antenna switches 2515 may be omitted from the configuration of the smart phone 2500.

The bus 2517 connects the processor 2501, the memory 2502, the storage device 2503, the external connection interface 2504, the camera 2506, the sensor 2507, the microphone 2508, the input device 2509, the display device 2510, the speaker 2511, the wireless communication interface 2512, and the auxiliary controller 2519 to each other. The battery 2518 supplies power to blocks of the smart phone 2500 shown in FIG. 13 via feeder lines, which are partially shown as dashed lines in the Figure. The auxiliary controller 2519 operates a minimum necessary function of the smart phone 2500, for example, in a sleep mode.

In the smart phone 2500 shown in FIG. 13, a transceiver of a device on user equipment side according to an embodiment of the present disclosure may be implemented by the wireless communication interface 2512. At least a part of functions of the processing circuitry and/or units of the electronic device or the information processing device on the user equipment side according to the embodiments of the present disclosure may also be implemented by the processor 2501 or the auxiliary controller 2519. For example, the auxiliary controller 2519 may perform a part of functions of the processor 2501, to reduce power consumption of the battery 2518. Further, the processor 2501 or the auxiliary controller 2519 may perform at least a part of functions of the processing circuitry and/or the units of the electronic device or the information processing device on the user equipment side according to the embodiments of the present disclosure by executing a program stored in the memory 2502 or the storage device 2503.

[Application Example with Regard to Base Station]

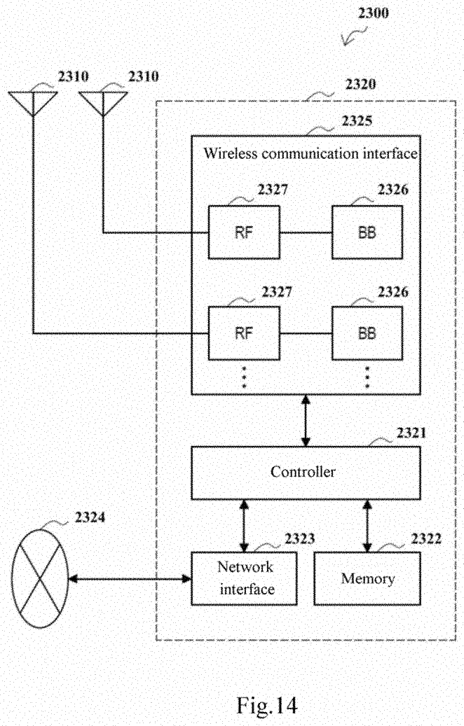

FIG. 14 is a block diagram showing an example of a schematic configuration of a gNB to which the technology according to the present disclosure may be applied. The gNB 2300 includes multiple antennas 2310 and a base station device 2320. The base station device 2320 and each of the antennas 2310 may be connected to each other via a radio frequency (RF) cable.

Each of the antennas 2310 includes single or more antenna elements (such as multiple antenna elements included in a multiple-input multiple-output (MIMO) antenna), and are used for transmitting and receiving a wireless signal by the base station device 2320. As shown in FIG. 14, the gNB 2300 may include multiple antennas 2310. For example, the multiple antennas 2310 may be compatible with multiple frequency bands used by the gNB 2300.

The base station device 2320 includes a controller 2321, a memory 2322, a network interface 2323, and a wireless communication interface 2325.

The controller 2321 may be for example a CPU or a DSP and operate various functions of higher layers of the base station device 2320. For example, the controller 2321 generates a data packet based on data in a signal processed by the wireless communication interface 2325, and transfers the generated packet via a network interface 2323. The controller 2321 may bundle data from multiple baseband processors to generate a bundled packet, and transfer the generated bundled packet. The controller 2321 may have a logic function for performing control such as wireless resource control, wireless carrying control, mobility management, admission control and schedule. The control may be performed in conjunction with an adjacent gNB or a core network node. The memory 2322 includes RAM and ROM, and stores programs executed by the controller 2321 and various types of control data (such as a terminal list, transmission power data and scheduling data).

The network interface 2323 is a communication interface for connecting the base station device 2320 to a core network 2324. The controller 2321 may communication with the core network node or another gNB via the network interface 2323. In this case, the gNB 2300 and the core network node or the other gNB may be connected to each other via a logic interface (such as an Si interface and an X2 interface). The network interface 2323 may also be a wired communication interface or a wireless communication interface for wireless backhaul line. If the network interface 2323 is a wireless communication interface, the network interface 2323 may use a higher frequency band for wireless communication than a frequency band used by the wireless communication interface 2325.

The wireless communication interface 2325 supports any cellular communication scheme (such as Long Term Evolution (LTE) and LTE-advanced), and provides a wireless connection to a terminal located in a cell of the gNB 2300 via the antenna 2310. The wireless communication interface 2325 usually may include for example a BB processor 2326 and an RF circuit 2327. The BB processor 2326 may perform for example encoding/decoding, modulating/demodulating and multiplexing/de-multiplexing, and perform various types of signal processing of layers (such as L1, medium access control (MAC), radio link control (RLC) and packet data convergence protocol (PDCP)). Instead of the controller 2321, the BB processor 2326 may have a part or all of the above logic functions. The BB processor 2326 may be a memory storing a communication control program, or a module including a processor and a related circuit which are configured to execute programs. Updating programs may change functions of the BB processor 2326. The module may be a card or a blade inserted into a slot of the base station device 2320. Alternatively, the module may be a chip installed on the card or the blade. Meanwhile, the RF circuit 2327 may include for example a mixer, a filter and an amplifier, and transmits and receives a wireless signal via the antenna 2310.

As shown in FIG. 14, the wireless communication interface 2325 may include multiple BB processors 2326. For example, the multiple BB processors 2326 may be compatible with multiple frequency bands used by the gNB 2300. As shown in FIG. 14, the wireless communication interface 2325 may include multiple RF circuits 2327. For example, the multiple RF circuits 2327 may be compatible with the multiple antenna elements. Although FIG. 14 shows an example in which the wireless communication interface 2325 includes the multiple BB processors 2326 and the multiple RF circuits 2327, the wireless communication interface 2325 may also include a single BB processor 2326 and a single RF circuit 2327.

In the gNB 2300 shown in FIG. 14, a transceiver of a wireless communication device on a base station side may be implemented by the wireless communication interface 2325. At least a part of the functions of the processing circuitry and/or various units of the electronic device or the wireless communication device on the base station side may also be implemented by the controller 2321. For example, the controller 2321 may perform at least a part of the functions of the processing circuitry and/or various units of the electronic device or the wireless communication device on the base station side by performing a program stored in the memory 2322.

In the above description of specific embodiments of the present disclosure, features described and/or illustrated for one embodiment may be used in one or more other embodiments in the same or similar manner, or may be combined with features in other embodiments, or may replace features in other embodiments.

It is be noted that, terms “including/comprising” used herein refer to existing of features, elements, steps or components, but existing or adding of one or more other features, elements, steps or components is not excluded.

In the above embodiments and examples, reference numerals consisting of numbers are used to represent steps and/or units. Those skilled in the art should understand that the reference numerals are used to facilitate describing and drawing, and are not intended to indicate an order or limitation in any way.

In addition, the method according to the present disclosure is not limited to be performed in the chronological order described herein, and may be performed in other chronological order, in parallel or independently. Therefore, the order in which the method is performed described herein does not limit the technical scope of the present disclosure.

Although the present disclosure is disclosed by the description of specific embodiments of the present disclosure above, it should be understood that all the embodiments and examples described above are only exemplary but not intended to limit. Various modifications, improvements or equivalents may be made to the present disclosure by those skilled in the art within the scope and spirit of the attached claims. The changes, improvements or equivalents should be regarded as falling within the protection scope of the present disclosure.

1. An electronic device for wireless communication, comprising processing circuitry configured to:
perform control to perform channel idle detection on an unlicensed band with a predetermined bandwidth; and
perform control based on a result of the channel idle detection to transmit a hybrid automatic repeat request on one or more sub-bandwidth blocks having the predetermined bandwidth.

2. The electronic device according to claim 1, wherein the processing circuitry is configured to:
select at least one sub-bandwidth block from sub-bandwidth blocks which are indicated to be idle by the channel idle detection, for transmitting the hybrid automatic repeat request.

3. The electronic device according to claim 1, wherein the processing circuitry is configured to:
transmit the hybrid automatic repeat request on each of sub-bandwidth blocks which are indicated to be idle by the channel idle detection.

4. The electronic device according to claim 1, wherein the processing circuitry is configured to:
transmit the hybrid automatic repeat request on sub-bandwidth blocks belonging to a predetermined set of sub-bandwidth blocks among sub-bandwidth blocks which are indicated to be idle by the channel idle detection.

5. The electronic device according to claim 4, wherein the predetermined set of sub-bandwidth blocks is configured by a base station.

6. The electronic device according to claim 1, wherein the processing circuitry is configured to:
perform control to transmit the hybrid automatic repeat request earlier on a sub-bandwidth block which passes the channel idle detection earlier.

7. The electronic device according to claim 1, wherein the processing circuitry is configured to:
select, according to a result of the channel idle detection, one or more of the sub-bandwidth blocks with high idle degree for the hybrid automatic repeat request.

8. The electronic device according to claim 7, wherein the processing circuitry is configured to:
remove influence of a downlink signal of a current serving cell in the channel idle detection.

9. The electronic device according to claim 7, wherein the idle degree is determined based on a received signal strength indication.

10. The electronic device according to claim 7, wherein the processing circuitry is further configured to:
perform control to receive indication information related to uplink channel occupation time transmitted by a base station, and not to perform signal transmission during the indicated uplink channel occupation time.

11. A wireless communication method, comprising:
performing channel idle detection on an unlicensed band with a predetermined bandwidth; and
transmitting, based on a result of the channel idle detection, a hybrid automatic repeat request on one or more sub-bandwidth blocks having the predetermined bandwidth.

12. An electronic device for wireless communication, comprising processing circuitry configured to:
perform control to receive a hybrid automatic repeat request on at least one sub-bandwidth block of an unlicensed band which has a predetermined bandwidth,
wherein the hybrid automatic repeat request is transmitted by user equipment on one or more of the sub-bandwidth block based on a result of channel idle detection performed with the predetermined bandwidth.

13. The electronic device according to claim 12, wherein the processing circuitry is configured to:
perform control to perform a detection on each of sub-bandwidth blocks of the allocated unlicensed band for receiving the hybrid automatic repeat request.

14. The electronic device according to claim 12, wherein the processing circuitry is configured to:
select a part of sub-bandwidth blocks of the allocated unlicensed band for receiving the hybrid automatic repeat request.

15. The electronic device according to claim 12, wherein the processing circuitry is configured to:
perform control to perform detection on a predetermined set of sub-bandwidth blocks of the allocated unlicensed band for receiving the hybrid automatic repeat request.

16. The electronic device according to claim 15, wherein the processing circuitry is further configured to:
perform control to transmit indication information related to the predetermined set of sub-bandwidth blocks to the user equipment.

17. The electronic device according to claim 12, wherein the processing circuitry is further configured to perform control to perform channel idle detection on the unlicensed band with the predetermined bandwidth; and
receive the hybrid automatic repeat request on one or more of the sub-bandwidth blocks with high idle degree.

18. The electronic device according to claim 17, wherein the processing circuitry is further configured to:
perform control to transmit indication information related to downlink channel occupation time of the unlicensed band to target user equipment, wherein the hybrid automatic repeat request is to be received from the target user equipment.

19. The electronic device according to claim 17, wherein the processing circuitry is further configured to:
perform control to transmit indication information related to uplink channel occupation time to user equipment other than target user equipment, wherein the hybrid automatic repeat request is to be received from the target user equipment.

20.-21. (canceled)
